(19) United States
(12) Patent Application Publication
(10) Pub. No.: US 2008/0187042 A1
(43) Pub. Date: Aug. 7, 2008

(54) Method of Processing a Video Signal Using Quantization Step Sizes Dynamically Based on Normal Flow

(75) Inventor: Radu Serban Jasinschi, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,890

(22) PCT Filed: Jan. 2, 2006
(86) PCT No.: PCT/IB2006/050004

§ 371 Date: Jun. 27, 2007

(30) Foreign Application Priority Data
Jan. 7, 2005 (EP) 05100068.5

(51) Int. Cl. H04N 7/26

(52) U.S. Cl. 375/240.03; 375/240.01; 375/E07.14

(57) ABSTRACT

There is described a method of processing a video input signal (50) in a data processor (20) to generate corresponding processed output data (40, 200). The method includes steps of: (a) receiving the video input signal (50) at the data processor (20), the input signal (50) including a sequence of images (100) wherein said images (100) are each represented by pixels; (b) grouping the pixels to generate several groups of pixels per image; (c) transforming the groups to corresponding representative transform parameters; (d) coding the transform parameters of the groups to generate corresponding quantized transform data; (e) processing the quantized transform data to generate the processed output data (40, 200) representative of the input signal. The method involves coding the transform parameters in step (d) using quantization step sizes which are dynamically variable as a function of spatio-temporal information conveyed in the sequence of images (100). The method enhances image quality in images regenerated from the output data (40, 200).

The present invention relates to methods of processing input data to generate corresponding processed output data. Moreover, the present invention also concerns further methods of processing the processed output data to regenerate a representation of the input data. Furthermore, the present invention also relates to apparatus operable to implement these methods, and also to systems including such apparatus. Additionally, the invention is susceptible to being implemented by hardware or, alternatively, software executable on computing hardware. The invention is pertinent to electronic devices, for example mobile telephones (cell phones), video recorders, computers, optical disc players and electronic cameras although not limited thereto.

In contemporary electronic apparatus and systems, it has been found that superior picture quality can be presented to viewers when such pictures are derived from digitized image data in comparison to analogue image signals. Such benefit pertains not only to broadcast image content, for example satellite TV, but also pre-recorded image content, for example as contemporarily provided from DVDs. On account of image sequences being capable when digitized of creating a relatively large amount of data, various schemes for compressing image data have been developed; some of these schemes have given rise to established international standards such as a series of MPEG standards. MPEG is an abbreviation for Moving Picture Expert Group.

In MPEG2 compression, it possible to compress digitized image data to generate MPEG compressed image data; such compression is capable of providing a data size reduction in a range of 40:1 to 60:1. An MPEG encoder is operable to classify a sequence of images into intra-(I) frames, predictive-(P) frames and bi-directional (B) frames. Use of the I-frames arises on account of group of pictures (GOP) structures being employed in the encoder. For example, a GOP structure can comprise a sequence of frames IPPBBBPPBBB which aims to achieve best quality for I-frames, less quality for P-frames, and wherein the B-frames are arranged to employ information from “past and future” frames, namely bi-directional information. GOP structures are determined prior to MPEG encoding and groupings employed are independent of video content information. Successive images within a GOP often change more gradually such that considerable data compression can be achieved by merely describing changes, for example in terms of flow vectors; such compression is achieved by use of the aforesaid P-frames and B-frames. During MPEG2 data compression, the images in the sequence are divided into macroblocks, wherein each macroblock conveniently comprises a two-dimension field of 16×16 pixels. Such macroblock generation involves dividing images into two fields in interlaced format. Each field includes half the number of lines of pixels of corresponding frames and the same number of columns of pixels of corresponding frames. Thus, a 16×16 frame macroblock becomes an 8×16 macroblock in a corresponding field. The aforesaid flow vectors are used to describe evolution of macroblocks from a given earlier image in the sequence to macroblocks of a subsequent image thereof.

In generating the MPEG compressed data, a transform is used to convert information of pixel brightness and color for selected macroblocks into corresponding parameters in the compressed data. According to the MPEG standards, a discrete cosine transformation (DCT) is beneficially employed to generate the parameters. The parameters are digital values representing a transform of digitized luminance and color information of corresponding macroblock pixels. Moreover, the parameters are conventionally quantized and clipped to be in a range of 1 to 31, namely represented by five binary bits in headers included in the MPEG compressed data. Moreover, a table look-up method is conveniently employed for quantizing DCT coefficients to generate the parameters.

In order to try to ensure that MPEG encoding of image data corresponding to a sequence of images yields manageable MPEG encoded output data rates, it is conventional practice to utilize a complexity calculator, for example as described in a published U.S. Pat. No. 6,463,100. The complexity calculator is operable to calculate spatial complexity of an image stored in memory. Moreover, the complexity calculator is coupled to a bit rate controller for controlling quantization rate for maintaining encoded output data rate within allowable limits, the bit rate controller being operable to control the quantization rate as a function of spatial complexity as computed by the complexity calculator. In particular, quantization employed in generating the output data is made coarser when high spatial complexity is identified by the complexity calculator and less coarse for lower spatial complexity. Thus, the spatial complexity is used to control the bit rate control for quantization. Also, a defined bit rate is allocated to a group of pictures (GOP) according to a transfer bit rate and bits are allocated to each image according to the complexity of each picture depending upon whether it is an I-frame, P-frame or B-frame.

Although data compression techniques described in U.S. Pat. No. 6,463,100 are capable of providing further data compression, it is found in practice that such compression can give rise to undesirable artifacts, especially when rapid changes of scene occur giving rise to momentarily potentially high data rates. In devising the present invention, the inventor has attempted to address this problem of undesirable artifacts when high degrees of data compression are used, thereby giving rise to more acceptable image quality after subsequent image data decompression.

An object of the present invention is to provide an improved method of processing a video input signal comprising a sequence of images in a data processor to generate corresponding processed output data representative of the sequence of images.

According to a first aspect of the invention, there is provided a method of processing a video input signal in a data processor to generate corresponding processed output data, said method including steps of:

(a) receiving the video input signal at the data processor, said video input signal including a sequence of images wherein said images are each represented by pixels;
(b) grouping the pixels to generate at least one group of pixels per image;
(c) transforming the at least one group to corresponding representative transform parameters;
(d) coding the transform parameters of the at least one group to generate corresponding quantized transform data;
(e) processing the quantized transform data to generate the processed output data representative of the video input signal,
characterized in that coding the transform parameters in step (d) is implemented using quantization step sizes which are dynamically variable as a function of spatio-temporal information conveyed in the sequence of images.

The invention is of advantage in that it is capable of generating processed output data which is a more acceptable representation of the video input signal for a given volume of data.

Optionally, in the method, the at least one group corresponds to at least one block of pixels. Use of pixel blocks renders the method applicable to improve conventional image processing methods which are based on block representations.

Optionally, in the method, the quantization step sizes employed for a given group are determined as a function of spatio-temporal information which is local thereto in the sequence of images. Use of both local spatial and local temporal information is of considerable benefit in that bits of data present in the processed output data can be allocated more effectively to more suitably represent the input video signal, whilst not requiring prohibitive computing resources in making such an allocation of bits.

Optionally, in the method, the quantization step sizes are determined as a function of statistical analysis of spatio-temporal information conveyed in the sequence of images. Such statistical analysis is susceptible to giving rise to statistical parameters which are more suitable indicators to determine parts of images in the input video signal which need to be processed to greater accuracy.

Optionally, in the method, the quantization step sizes are determined as a function of a normal flow arising within each group in said sequence of images, said normal flow being a local component of image velocity associated with the group. More optionally, in the method, the normal flow is computed locally for each group from at least one of image brightness data and image color data associated with the group. Use of the normal flow as a parameter for determining appropriate quantization steps is found in practice to provide better data compression results at subsequent decompression in comparison to other contemporary advanced image compression techniques.

Optionally, in the method, the statistic analysis of the normal flow involves computing a magnitude of a mean and a variance of the normal flow for each group. In practice, the variance of the normal flow is especially useful for determining where most efficiently to allocate bits when compression sequences of images.

Optionally, in the method, adjustment of the quantization step sizes for a given group is implemented in a linear manner substantially according to a relationship:

q_{—}sc_{—}m=((δ·q_{—}sc)±(λ·Γ(x)))

wherein
Γ(x)=x·e^{-(x-1)}, namely a shifted Gamma or Erlang function giving rise to non-linear modulation;
x=normal flow magnitude variance;
λ=a multiplying coefficient;
δ=a multiplying coefficient; and
q_sc=a quantization scale.

Such a relationship is capable of yet further resulting in more efficient allocation of bits when compressing sequences of images.

Optionally, the method is adapted to employ a discrete cosine transform (DCT) in step (c) and to generate groups of pixels in accordance with MPEG standards. Adapting the method to contemporary MPEG standards is capable of rendering the method workable with existing systems and equipment with relatively little change thereto being required.

According to a second aspect of the invention, there is provided processed video data generated according to the method according to the first aspect of the invention, said data being processed using quantization step sizes which are dynamically variable as a function of spatio-temporal information present in a sequence of images represented by said processed video data.

Optionally, the processed video data is stored on a data carrier, for example a DVD.

According to a third aspect of the invention, there is provided a processor for receiving video input signals and generating corresponding processed output data, the processor being operable to apply the method according to the first aspect of the invention in generating the processed output data.

According to a fourth aspect of the invention, there is provided a method of decoding processed input data in a data processor to generate decoded video output data corresponding to a sequence of images, characterized in that said method includes steps of:

(a) receiving the processed input data at the data processor;
(b) processing the processed input data to generate corresponding quantized transform data;
(c) processing the quantized transform data to generate transform parameters of at least one group of pixels of the sequence of images, said processing of the transform data utilizing quantization having quantization step sizes;
(d) decoding the transform parameters into corresponding groups of pixels; and
(e) processing the groups of pixels to generate the corresponding sequence of images for inclusion in the decoded video output data,
wherein the data processor is operable in step (d) to decode using quantization steps sizes that are dynamically variable as a function of spatio-temporal information conveyed in the sequence of images.

Optionally, in the method, the at least one group of pixels correspond to at least one block of pixels.

Optionally, in the method, the quantization step sizes employed for a given group are made dependent on spatio-temporal information which is local to the given group in the sequence of images. More optionally, in the method, the quantization step sizes are determined as a function of statistical analysis of spatio-temporal information conveyed in the sequence of images.

Optionally, in the method, the quantization step sizes are determined as a function of a normal flow arising within each group in said sequence of images, said normal flow being a local component of image velocity associated with the group.

Optionally, in the method, said normal flow is computed locally for each group from at least one of image brightness data and image color data associated with the group.

Optionally, in the method, said statistic analysis of the normal flow involves computing a magnitude of a mean and a variance of the normal flow for each macroblock.

Optionally, in the method, adjustment of the quantization step sizes for a given group is implemented in a linear manner substantially according to:

q_{—}sc_{—}m=((δ·q_{—}sc)±(λ·Γ(x)))

wherein
Γ(x)=x·e^{-(x-1)}, namely a shifted Gamma or Erlang function giving rise to non-linear modulation;
x=normal flow magnitude variance;
λ=a multiplying coefficient;
δ=a multiplying coefficient; and
q_sc=a quantization scale

Optionally, the method is adapted to employ a discrete cosine transform (DCT) in step (d) and to process groups of pixels in accordance with MPEG standards.

According to a fifth aspect of the invention, there is provided a processor for decoding processed input data therein to generate video output data corresponding to a sequence of images, said processor being operable to employ a method according to the fourth aspect of the invention for generating the video output data.

According to a sixth aspect of the invention, there is provided an apparatus for processing video data corresponding to a sequence of images, said apparatus including at least one of: a processor according to the third aspect of the invention, a processor according to the fifth aspect of the invention. Optionally, said apparatus is implemented as at least one of: a mobile telephone, a television receiver, a video recorder, a computer, a portable lap-top computer, a portable DVD player, a camera for taking pictures.

According to a seventh aspect of the invention, there is provided a system for distributing video data, said system including:

(a) a first processor according to the third aspect of the invention for receiving video input signals corresponding to a sequence of images and generating corresponding processed output data;
(b) a second processor according to the fifth aspect of the invention for decoding the processed output data therein to generate video data corresponding to the sequence of images; and
(c) a data conveying arrangement for conveying the encoded data from the first processor to the second processor.

Optionally, in the system, said data conveying arrangement includes at least one of: a data storage medium, a data distribution network. For example, the system can be implemented via the Internet or via a mobile telephone (cell-phone) network.

According to an eighth aspect of the invention, there is provided software for executing in computing hardware for implementing the method according to the first aspect of the invention.

According to a ninth aspect of the invention, there is provided software for executing in computing hardware for implementing the method according to the fourth aspect of the invention.

It will be appreciated that features of the invention are susceptible to being combined in any combination without departing from the scope of the invention.

Embodiments of the invention will now be described, by way of example only, with reference to the following diagrams wherein:

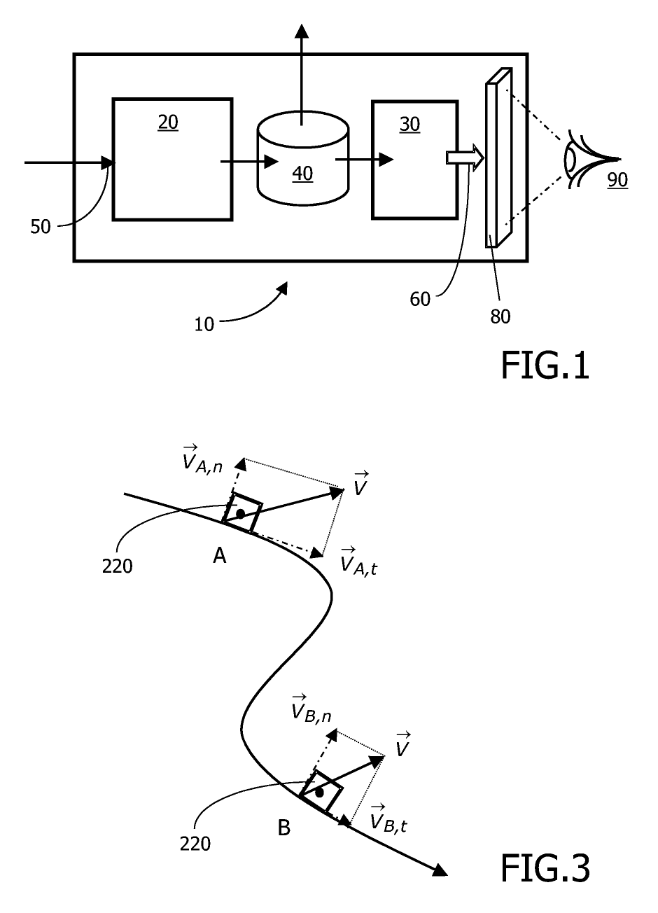

FIG. 1 is a schematic diagram of system according to the invention, the system comprising a first processor for processing a video input signal to generate corresponding compressed processed output data, and a second processor for processing the processed output data to generate a representation of the video input signal;

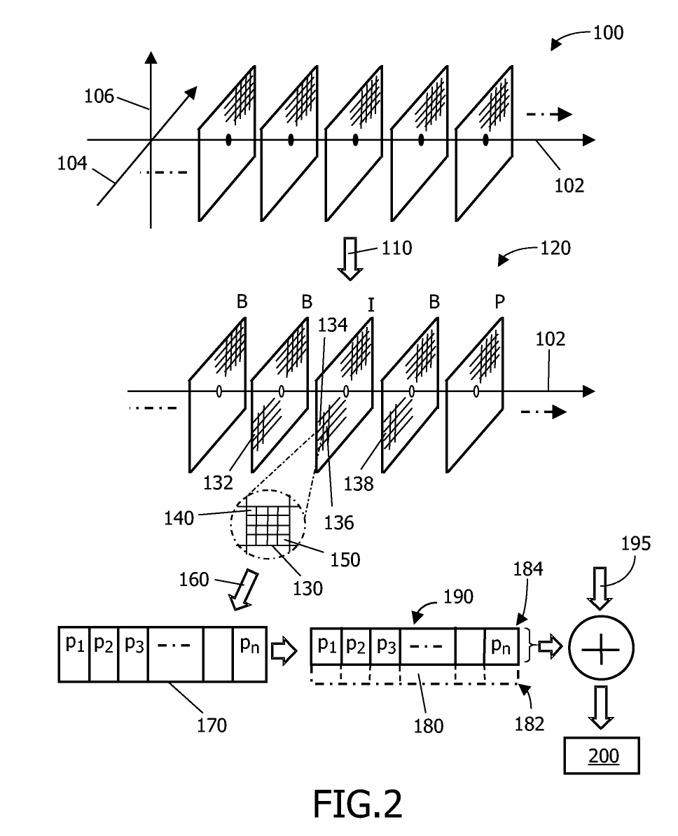

FIG. 2 is a schematic diagram of data compression executed within the first processor of the system of FIG. 1;

FIG. 3 is a schematic diagram of normal and tangential flows at two points of a contour moving with a uniform velocity \vec{V};

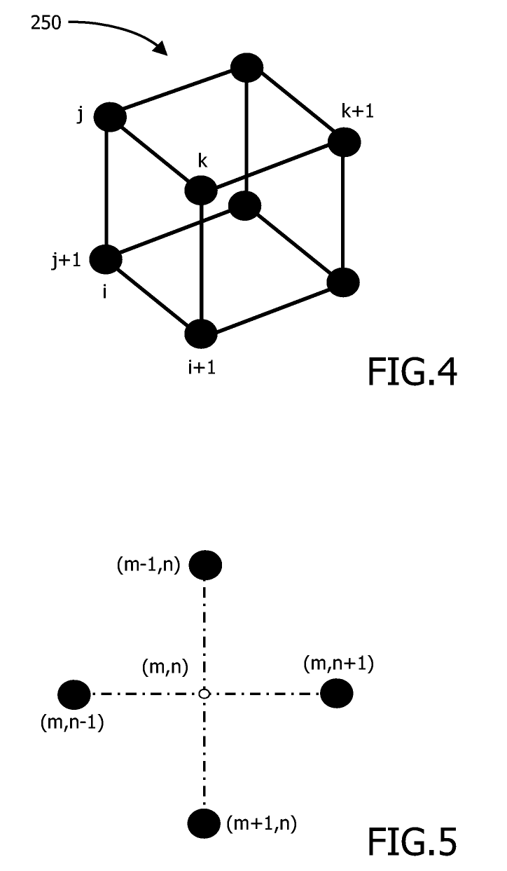

FIG. 4 is a schematic illustration of a 2×2×2 image brightness cube representation utilized for determining flows in the first processor in FIG. 1;

FIG. 5 is a first-order neighbourhood used to smooth out normal flow variance;

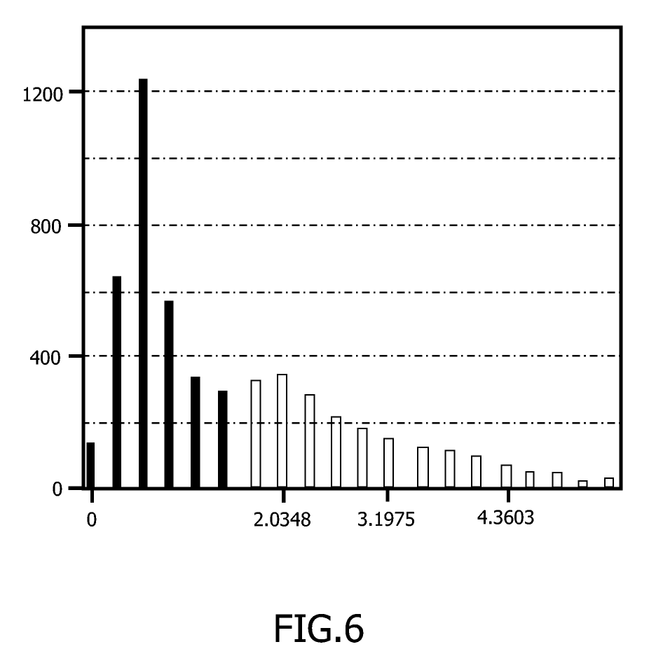

FIG. 6 is an example normal flow magnitude variance histogram;

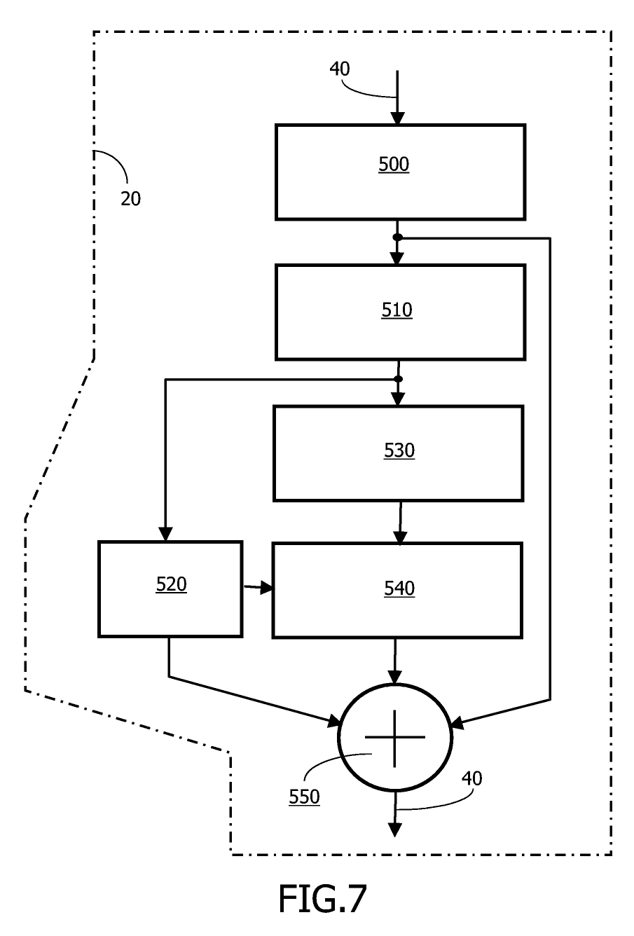

FIG. 7 is a schematic diagram of functions executed within the first processor of the system in FIG. 1; and

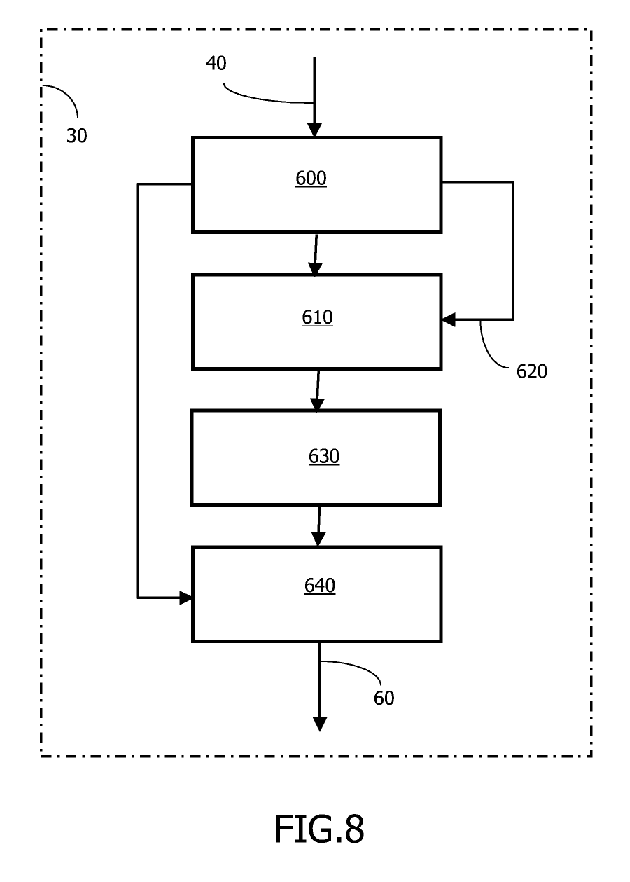

FIG. 8 is a schematic diagram of functions executed within the second processor of the system of FIG. 1.

Referring to FIG. 1, there is shown a system according to the invention, the system being indicated generally by 10. The system 10 comprises a first processor 20, a second processor 30, and an arrangement for conveying data 40 from the first processor 20 to the second processor 30. Moreover, the first processor 20 is coupled at its input 50 to a data source providing an input video signal including a temporal sequence of images. Moreover, the second processor 30 includes an output 60 for providing decompressed image output data susceptible to generating images for presentation via an image monitor 80 to a user 90 of the system 10; the decompressed image output data is a representation of images included in the input video signal. The image monitor 80 can be any type of generic display, for example a liquid crystal device (LCD), a plasma display, a cathode ray tube (CRT) display, a light emitting diode (LED) display, and an electroluminescent display. The arrangement for conveying data 40 from the first processor 20 to the second processor 30 is susceptible to being implemented is several different ways, for example at least one of:

(a) via a data communication network, for example the Internet;
(b) via a terrestrial wireless broadcast network, for example via a wireless local area network (WAN), via satellite transmission or via ultra-high frequency transmission; and
(c) via a data carrier such as a magnetic hard disc, an optical disc such as a DVD, a solid-state memory device such as a data memory card or module.

The first and second processors 20, 30 are susceptible to being implemented using custom hardware, for example application specific integrated circuits (ASICs), in computing hardware operable to execute suitable software, and in any mixture of such hardware and computing hardware with associated software. The present invention is especially concerned with data compression processes occurring in the first processor 20 as will be described in greater detail later.

Referring to FIG. 2, there is shown a schematic overview of MPEG-like image processing executed within the first processor 20. A sequence of images provided at the input 50 is indicated generally by 100. The sequence 100 is shown with reference to a time axis 102 wherein a left-side image in the sequence is earlier than a right-side image. There are additionally provided mutually orthogonal spatial axes 104, 106. Each image in the sequence 100 comprises an array of pixel elements, also known as pels. The sequence 100 is processed, as denoted by an arrow 110, in the processor 20 to determine those pictures suitable for forming initial I-frames (I) of groups of pictures (GOPs). Other pictures which are capable of being predicted from such I-frames are designated as B-frame or P-frame as described in the foregoing. When, for example, an I-frame in the sequence 100 is identified, the I-frame is sub-divided into macroblocks, for example a macroblock 130 including 16×16 pels, for example with pels 140, 150 being diagonally opposite pels of the macroblock 130. The macroblock 130 is neighbored by spatially adjacent macroblocks, for example macroblocks 134, 136, and temporally adjacent macroblocks, for example macroblocks 132, 138; spatially adjacent and temporally adjacent macroblocks are also referred to as being spatially and temporally local macroblocks herein. Each of the macroblocks are then processed by way of a transform denoted by an arrow 160, for example a discrete cosine transform (DCT) or alternative such as a wave transform, to generate corresponding sequences of parameters 170 including parameters p₁ to pₙ, n being an integer corresponding to the number of transform parameters required to represent each transformed macroblock. The parameters 170 each include a most significant bit 184 and a least significant bit 182. Less significant bits of the parameters p₁ to pₙ are removed by quantization as denoted by 180 to yield a sequence of more significant bits of the parameters p₁ to pₙ indicated by 190. The sequence of more significant bits 190 is combined with other data 195, for example header data, pertaining to the sequence of images 100 to generate compressed output data denoted by 200; such compression using, for example, contemporarily-known entropy encoding. The output data 200 is then output from the processor 20 for storage or transmission as the aforesaid data 40. Of relevance to the present invention is the size of quantization step applied to the parameters 170 to generate corresponding quantized parameters 190, namely the number of data bits represented in a region 180 shown,

It is known, as elucidated in the foregoing, to vary the quantization step applied to the parameters p₁ to pₙ on an image frame-by-frame basis. Moreover, it is also known to render the quantization step size to be a function of spatial information included within each of the frames, for example spatial complexity. The first processor 20 is distinguished from such known approaches in that the quantization step size is varied within frames or groups of macroblocks, each group including one or more macroblocks. Moreover, the quantization step size is both a function of spatial complexity around each group and also temporal activity around each group.

For example, in the processor 20, the macroblock 130 gives rise to the parameters 170 as depicted, these parameters 170 being subsequently quantized using a quantization step size represented by 180, wherein the step size 180 is a function of spatial complexity information derived from, amongst others, the spatially neighboring macroblocks 134, 136, as well as temporal information derived from the temporally neighboring macroblocks 132, 138.

By varying the quantization step size on a macroblock basis, it is possible to include detail in the output data 200 relating to image features that are most perceptible to viewers and thereby enhance image quality for a given volume of output data 200. Thus, the processor 20 is capable of using bits in the output data 200 more optimally than has hitherto been possible for enhancing regenerated image quality in the second processor 30.

In summary, the inventor has appreciated that normal flow arising within images in the sequence 100 is a useful parameter for controlling the aforesaid quantization step size. Normal flow takes into account information pertaining to object shape, object texture fine features and its apparent motion. Optionally, the inventor has found that a variance of the normal flow magnitude is an especially useful measure for determining most optimal quantization step size to employ when processing any given macroblock of group of macroblocks within an image frame. For example, the quantization scale, and hence quantization step size, q_sc_m is beneficially substantially a function of the variance of the normal flow magnitude as provided in Equation 1.1 (Eq. 1.1):

q_{—}sc_{—}m=((δ·q_{—}sc)±(λ·Γ(x))) Eq. 1.1

wherein
Γ(x)=x·e^{-(x-1)}, namely a shifted Gamma or Erlang function giving rise to non-linear modulation;
x=normal flow magnitude variance;
λ=multiplying coefficient;
δ=multiplying coefficient; and
q_sc=quantization scale.

Moreover, the inventor has found from experiments that the variance v varies considerably such that it is not ideal as a parameter from which to directly derive an appropriate value of quantization step for processing each macroblock or group of macroblocks. The inventor has appreciated, although such variance not appearing superficially ideal to use, that it is beneficial to take into account the probability distribution of the variances, for example a tail in a probability distribution, so that the variance v can be processed to generate an appropriate number from which the quantization step size can be derived.

The present invention is of benefit in that it is capable of improving image quality locally within an image, especially when the amount of spatial texture is high as well as when the local details also vary in time. If adaptive quantization according to the present invention is not used for more complex sequences of images, for example videos, visual artifacts will occur; such visual artifacts include, for example, blockiness. Conventionally, in contradistinction to the present invention, a uniform quantization scale used for all macroblocks in a given image will result in corresponding macroblocks potentially containing more spatial and temporal texture than necessary or details will not be provided with an appropriate number of bits to represent all the details adequately. Thus, an adaptive quantization scheme according to the present invention is capable of reducing the probability of noticeable blockiness being observed, such reduction being achieved by a more appropriate distribution of bits per frame, namely frame macroblocks, based on spatial texture, temporal texture and image motion.

An embodiment of the invention of the invention will now be described in more detail.

The aforesaid normal flow is defined as a normal component, namely parallel to a spatial image gradient, of a local image velocity or optical flow. The normal image velocity can be decomposed at each pixel in the sequence of images 100 into normal and tangential components as depicted in FIG. 3. These two components are especially easy to appreciate at a well-defined image boundary or when a contour passes a given target pixel 220 as depicted. For example, when progressing along a boundary from a point A to a point B, normal and tangential image velocities associated with the pixel 220 at point A change their change spatial orientations at the point B; the normal and tangential velocities at point A are denoted by V_{A,n}, v_{A,t} respectively, whereas the normal and tangential velocities at point B are denoted by V_{B,n}, v_{B,t} respectively.

As illustrated in FIG. 3, the normal and tangential flows are always mutually 90° orthogonal. An important property of the normal flow is that it is the only image velocity component that can be relatively directly computed; the tangential component cannot reasonably be computed. Computation of the normal flow will now be further elucidated.

The image brightness is denoted by I(x, y) for a point P. This brightness is, for derivation purposes, constant as the point P moves from a first position (x, y) at a time t to a second position (x′, y′) at a time t′=t+Δt. Spatial co-ordinates of the point P are therefore expressible pursuant to Equation 1.2 (Eq. 1.2):

(x′, y′)=(x, y)+\vec{V}·Δt Eq. 1.2

wherein \vec{V} is a velocity vector pertaining to the movement from the first to the second position, this vector including corresponding vector components vₓ and v_{y} as illustrated in FIG. 3.

To an approximation when ΔT is relatively small, Equations 1.3 (Eqs. 1.3) pertain:

x′=x+(vₓ·Δt)

y′=y+(v_{y}·Δt)

t′=t+Δt Eq. 1.3

A Taylor expansion can then be applied to approximately equate brightness at the first and second positions, namely I(x′, y′, t′)≈I(x, y, t) in Equation 1.4 (Eq. 1.4) wherein a Taylor expansion of I(x′, y′, t′) is shown up to first order in Δt, where higher order expansion terms are ignored:

$$\begin{matrix}I ( {x}^{′} , {y}^{′} {t}^{′} ) = I ( x + {v}_{x} \cdot Δ t , y + {v}_{y} \cdot Δ t , t + Δ t ) \\ = {v}_{x} \cdot Δ t \cdot \frac{\partial I ( {x}^{′} , {y}^{′} , {t}^{′} )}{\partial x} {\vert}_{{x}^{′} = x , {y}^{′} = y , {t}^{′} = t} + \\ {v}_{y} \cdot Δ t \cdot \frac{\partial I ( {x}^{′} , {y}^{′} , {t}^{′} )}{\partial y} {\vert}_{{x}^{′} = x , {y}^{′} = {yt}^{*} = t} + \\ Δ t \frac{\partial I ( {x}^{′} , {y}^{′} , {t}^{′} )}{\partial t} {\vert}_{{x}^{′} = x , {y}^{′} = y , {t}^{′} = t} \\ \approx I ( x , y , t )\end{matrix} \qquad Eq . 1.4$$

Since I(x′, y′, t′)≈I(x, y, t), it is possible to derive from Equation 1.4 a corresponding Equation 1.5 (Eq. 1.5):

$$\vec{v} \cdot \vec{∇} I ( x , y , t ) + \frac{\partial I ( x , y , t )}{\partial t} \approx 0 \qquad Eq . 1.5$$

wherein

$$\vec{∇} ≡ ( \frac{\partial }{\partial x} , \frac{\partial }{\partial y} ) ; \qquad Eq . 1.6$$

\vec{a}·\vec{b} denotes in Equation 1.5 the scalar product of vectors \vec{a} and \vec{b}; and

$$\vec{v} \cdot \vec{∇} I ( x , y , t ) ≡ {v}_{x} \cdot \frac{\partial I ( x , y , t )}{\partial x} + {v}_{y} \frac{\partial I ( x , y , t )}{\partial y} \qquad Eq . 1.7$$

From inspection of FIG. 3, it will be appreciated that \vec{v}=\vec{v}ₙ+\vec{v}ₜ ignoring references to points A and B; a vector \vec{v}ₙ is a normal component of the vector \vec{v} with respect to image iso-brightness lines, namely edges, that are perpendicular to the aforesaid image brightness gradient \vec{∇}I(x, y, t); a vector \vec{v}ₜ is a tangential component of the vector \vec{v} and is perpendicular to the normal vector \vec{v}ₙ and \vec{∇}I(x, y, t). Equation 1.7 (Eq. 1.7) can be reduced to generate Equation 1.8 (Eq. 1.8):

$${v}_{n} \cdot \vec{∇} I ( x , y , t ) + \frac{\partial I ( x , y , t )}{\partial t} \approx 0 \qquad Eq . 1.8$$

from which a magnitude of the normal flow vector \vec{v}ₙ can be computed according to Equation 1.9 (Eq. 1.9):

$$\vert {\vec{v}}_{n} \vert = \frac{\vert \frac{\partial I ( x , y , t )}{\partial t} \vert}{\vert ∇ I ( x , y , t ) \vert} \qquad Eq . 1.9$$

and a unit vector direction of the normal flow vector \vec{v}ₙ can be computed according to Equation 1.10 (Eq. 1.10):

$$\hat{n} ≡ \frac{\vec{∇} I ( x , y , t )}{\vert \vec{∇} I ( x , y , t ) \vert} \qquad Eq . 1.10$$

The normal flow as provided in Equations 1.9 and 1.10 in distinction to image velocity, also serves as a measure of local image brightness gradient orientation. Variability in direction of the normal flow vector as provided by Equation 1.10 is also an implicit measure of an amount of image spatial texture per unit area of image, this measure being useable to determine suitable quantization step sizes to use when implementing the present invention.

In the processor 20, Equations 1.9 and 1.10 are computed in a discrete manner by approximating I(x, y, t) by I[i][j][k] wherein i, j and k are indices. By adopting such a discrete approach, it is then feasible to compute approximations of spatial and temporal derivatives using an image brightness cube representation indicated generally by 250 in FIG. 4. The brightness cube representation has brightness values defined for each vertex of the cube. In the processor 20, statistics of the normal flow are computed as will be elucidated in more detail later.

Given two successive image frames I₁ and I₂ present in the sequence of images 120 as illustrated in FIG. 2, the variance of the normal flow magnitude is calculable in the processor 20 using an algorithm whose steps are described in overview in Table 1:

TABLE 1

| Step | Function executed |
|---|---|
| 1 | Divide the images I₁, I₂ into non-overlapping groups of pels, |
| | for example square or rectangular blocks of pels. |
| 2 | Compute within each group of pels or for each pels a normal |
| | flow magnitude variance (see Eqs. 1.9 and 1.10). |
| 3 | Determine for each group an average value of normal |
| | flow magnitude based on results generated in Step 2. |
| 4 | Compute a value for the variance based on the computed normal |
| | flow magnitude and its average from Steps 2 and 3. |
| 5 | Given a threshold Tₛₜₐₜ, select a set of groups for which the |
| | variance computed in Step 4 is larger than Tₛₜₐₜ. |

The average computed in Step 3 is conveniently denoted by μ_{B}. Similarly, the variance computed in Step 2 is conveniently denoted by σ_{B}. Values for μ_{B} and σ_{B} for a group of N×N pels, namely an image block of size N×N pels, are computable in the processor 20 using Equations 2.1 and 2.2 (Eq. 2.1 and 2.2):

$$\begin{matrix}{μ}_{B} = \frac{1}{N} {\sum }_{i = 1}^{N} \vert {\vec{v}}_{n , i} \vert & Eq . 2.1 \\ {σ}_{B} = \sqrt{\frac{1}{N} \cdot {( \vec{{v}_{n , i}} - {μ}_{B} )}^{2}} & Eq . 2.2\end{matrix}$$

Optionally, when performing image processing in the processor 20, the groups of pels are selected to be blocks of pels, for example blocks of 8×8 pels or 16×16 pels. Use of such blocks results in images being tessellated into square blocks; any remainder of the picture remains untessellated. Generation of the blocks of peels is handled by the encoder 20; however, the input video beneficially has appropriate image dimensions so that interrelated peels do not occur. More optionally, in order to reduce residual untessellated image regions, a rectangular tessellation can be used and the variance of the normal flow employed; however, such an approach of employing rectangular groupings can potentially cause alignment problems with regard to standards such as MPEG 8×8 (DCT) pr MPEG 16×16 (MC).

In executing processing in the processor 20, computation of feature values within each group, for example block, is realized either:

(a) at each pels, namely pixel, for which |∇I(x, y, t)| is larger than a predetermined threshold T; or
(b) at feature points for which |∇I(x, y, t)| is larger than a pre-determined threshold T_{Gr}.

Beneficially, the thresholds T and T_{Gr} are set such that T<T_{Gr}.

The embodiment of the invention described in the foregoing is susceptible to including further refinements. A first optional feature is image registration. Moreover, a second optional feature is smoothing as a post-processing of normal flow magnitude variance.

Inclusion of image registration in processing functions executed by the processor 20 is capable of taking into account effects arising due to fast camera motion, for example panning and zooming operations. This feature is added to the steps outlined in Table 1 in the form of a velocity compensation per group of pels, for example per macroblock. A reason for needing to include such compensation arises on account of Equations 1.9 and 1.10 (Eq. 1.9 and 1.10) being approximations, namely a first order Taylor expansion of Δt which is only reasonably accurate for small to medium image velocity values. By registering consecutive images with respect to their global image velocity, it is possible to compute the aforesaid normal flow for a given image and its register pair image instead of consecutive images. Such motion compensation then renders the aforesaid approximation appropriate to use; once the images have been registered, for example to compensate for camera motion, the residual motion for which the normal flow is computed is sufficiently small to satisfy the constraints of the approximation employing a Taylor expansion. Conveniently, a 3DRS method of velocity estimation is employed per macroblock when implementing the motion compensation; the 3DRS method was developed by Philips BV and exploits a characteristics that any per macroblock block-based motion estimation is suitable for registration.

Inclusion of smoothing as a post-processing of normal flow magnitude variance is preferably implemented in the processor 20 by using first order neighborhood information as depicted in FIG. 5. When implementing such smoothing, the normal flow magnitude variance computed for a given group of pels, for example for a given block (m, n) of m×n pels, is beneficially averaged as a function of neighboring groups, for example blocks (m, n−1), (m, n+1), (m, n+1), (m−1, n) and (m+1, n). Such immediately adjacent blocks are known as a first order neighborhood. Application of such smoothing of this variance for the given group, renders resulting smoothed variance values less prone to being affected by subtle variations.

When performing image processing as described in the foregoing in the processor 20, it is convenient to employ groups of pels implemented as 8×8 pixels which align with a standard MPEG image grid. These groups correspond to I-frame DCT/IDCT computation and describe spatial detail information. Alternatively, when performing image processing as elucidated above in the processor 20, it is also convenient to employ groups of pels implemented as 16×16 pixels which align with a MPEG image grid when processing P-frame and B-frame macroblocks for performing motion compensation (MC) in block-based motion estimation compliant with MPEG/H.26x video standards. Such an implementation allows for spatio-temporal information to be described.

In the foregoing, it is described that the quantization step size is varied as a function of normal flow, optionally the variance of the normal flow magnitude or statistics thereof, such as mean and variance. The quantization step size is in turn determined by the quantization scale denoted by q_sc which is adaptively modified as a function of the normal flow variance. From experiments, it has been appreciated by the inventor that the normal flow magnitude variance σᵥ_{ₙ}, for example as computed from Equation 2.2 (Eq. 2.2), has a histogram whose profile is a relatively close fit to a Gamma-type function, such function also known as an Erlang function. An example of such a variance distribution is illustrated in a histogram of normal flow variance presented in FIG. 5. The inventor has also appreciated from experiments that the normal flow magnitude variance has a relatively low value in image areas having low spatial texture; such low values are represented by black histogram bars in FIG. 5. When given macroblocks move at variable velocities, relatively higher values of variance are generated as represented by white histogram bars in FIG. 5. Conveniently, a multi-partitioning model for the quantization scale used per group of pels, for example macroblocks, is employed; the multi-partitioning model includes two or more partitions. Optionally, a tri-partition model is employed with three different scale factors used as defined by Equations 3.1 to 3.3 (EQ. 3.1 to 3.3) when generated the output data 40:

q_{—}m_low=((δ_{low}·q)+(λ_{low}·Γ(x))) Eq. 3.1

q_{—}m_mid=((δ_{mid}·q)−(λ_{mid}·Γ(x))) Eq. 3.2

q_{—}m_high=((δ_{high}·q)−(λ_{high}·Γ(x))) Eq. 3.3

wherein q-m and q are parameters describing the modulated and un-modulated quantization scales respectively. Moreover, an expression Γ(x)=x·exp(−(x−1)) is included to represent a Gamma function. Parameters δ and λ are adjustable parameters. Moreover, the addition “+” in Equation 3.1 is included for modeling image areas corresponding to a low magnitude of normal flow magnitude variance. Furthermore, the subtractions “−” in Equations 3.2 and 3.3 are included for coping best with textured regions in images. Terms “low”, “mid” and “high” are included to denote low, medium and high quantization scale factors respectively.

Use of multi-partitioning is of advantage in obtaining more favorable data compression in the output data 200 as a continuous range of potential quantization scale factors, and hence quantization step sizes, does not need to be supported by the processor 20. For example, modulated quantization scale factor selected per group of pels for tri-partitioning can be represented with two data bits in the output data 200 even despite the scale factors adopted for the partitioning being of greater resolution, for example pursuant to a 5-bit scale. Optionally, the number of multi-partitions is at least 5 times less than the actual resolution possible for the scale factors.

The present invention is capable of improving the visual quality of DVD+RW recordings when employed in DVD+RW devices. Moreover, the invention is also relevant to high-performance televisions for which appropriate de-interlacing and presented image sharpness improvement is a contemporary technological problem, especially in view of the increased use of digital display devices wherein new types of digital display artifacts are encountered. Furthermore, the invention is also relevant to mobile telephones (cell phones) personal data assistants (PDAs), electronic games and similar personal electronic devices capable of presenting images to users; such devices are contemporarily often provided with electronic pixel-array cameras whose output signals are subject to data compression prior to being stored, for example on a miniature hard disc drive, optical disc drive or in solid-state memory of such devices. The present invention also pertains to image data communicated, for example by wireless, to such devices.

In the system 10, the second processor 30 is designed to accept the compressed data 40 and decompress it, applying where required variable quantization steps size within each image frame represented in the data 40 for generating the data 60 for presentation on the display 80 to the user 90. When regenerating groups of pels, for example macroblocks, the processor 30 applies variable quantization steps size in regenerating parameters which are subject to an inverse transform, for example an inverse discrete cosine transform (IDCT), to regenerate groups of pels, for example macroblocks, for reassembling a representation of the sequence of images 100; the inverse discrete cosine transform (IDCT) is conveniently implemented by way of a look-up table. The processor 30 is thus designed to recognize the inclusion of additional parameters in the data 40 indicative of quantization step size to employ; optionally, these parameters can be indicative of particular a multi-partitioning pre-declared quantization scale factors in a manner as outlined with reference to Equations 3.1 to 3.3 in the foregoing.

Processing operations performed in the processor 30 are schematically illustrated in FIG. 7 whose functions are listed in Table 2. However, other implementations of these operations are also feasible. Functions 500 to 550 described in Table 2 are executed in a sequence as indicated by arrows in FIG. 7.

TABLE 2

| Drawing feature | Representation |
|---|---|
| 40 | Compressed data |
| 50 | Input for receiving input image data |
| 500 | Function to perform image analysis |
| 510 | Function to partition image into |
| | groups of pels, for example macroblocks |
| 520 | Function to perform analysis of normal |
| | flow, its variance and related statistics |
| 530 | Function to transform groups of pels, for |
| | example macroblocks, into corresponding |
| | representative parameters, for example |
| | Discrete Fourier Transform (DCT) |
| 540 | Function to implement variable quantization |
| | step size processing of the parameters from |
| | the function 530 |
| 550 | Function to merge the quantized parameters |
| | from the function 540 with other image |
| | processing data to generate the compressed |
| | output data 40 |
| 560 | Parameters p as illustrated in 170 (FIG. 2) |

Processing operations performed in the processor 20, for example to implement Steps 1 to 5 as described in Table 1, are schematically illustrated in FIG. 8 whose functions are listed in Table 3. However, other implementations of these operations are also feasible. Functions 600 to 640 described in Table 3 are executed in a sequence as indicated by arrows in FIG. 8.

TABLE 3

| Drawing | |
|---|---|
| feature | Representation |
| 40 | Compressed data |
| 60 | Decompressed output data suitable for presentation to |
| | the viewer 90 |
| 600 | Function to perform sorting of compressed data, for |
| | example identify headers, various global parameters and |
| | similar |
| 610 | Function to process parameters subject to quantization |
| | in the processor 20 using variable quantization step |
| | size as a function normal flow variance |
| 620 | Parameter indicative of variable quantization step size |
| | or variable quantization scale employed |
| 630 | Inverse transform to transform parameters to groupings of |
| | pels, for example macroblocks, the function optionally |
| | being an inverse discrete Fourier transform (IDCT) |
| 640 | Function to assemble macroblocks together and to |
| | perform related processing, for example predictive |
| | processing, to generate a representation of the sequence |
| | of images 100 |

As described earlier, the processors 20, 30 are conveniently implemented by way of computing hardware operable to execute suitable software. However, other implementations are possible, for example dedicated custom digital hardware.

It will be appreciated that embodiments of the invention described in the foregoing are susceptible to being modified without departing from the scope of the invention as defined by the accompanying claims.

In the accompanying claims, numerals and other symbols included within brackets are included to assist understanding of the claims and are not intended to limit the scope of the claims in any way.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

Operable to employ a method means that there are means (e.g. one for each step) arranged or arrangeable to perform the method steps, e.g. as software running on a processor or hardware like an ASIC.

1. A method of processing a video input signal (50) in a data processor (20) to generate corresponding processed output data (40, 200), said method including steps of:
(a) receiving the video input signal (50) at the data processor (20), said video input signal (50) including a sequence of images (100) wherein said images are each represented by pixels;
(b) grouping the pixels to generate at least one group of pixels per image;
(c) transforming the at least one group to corresponding representative transform parameters;
(d) coding the transform parameters of the at least one group to generate corresponding quantized transform data;
(e) processing the quantized transform data to generate the processed output data representative of the video input signal (40, 200),
characterized in that coding the transform parameters in step (d) is implemented using quantization step sizes which are dynamically variable as a function of spatio-temporal information conveyed in the sequence of images.

2. A method as claimed in claim 1, wherein the at least one group corresponds to at least one block of pixels.

3. A method as claimed in claim 1, wherein the quantization step sizes employed for a given group are determined as a function of spatio-temporal information which is local thereto in the sequence of images.

4. A method as claimed in claim 1, wherein the quantization step sizes are determined as a function of statistical analysis of spatio-temporal information conveyed in the sequence of images.

5. A method as claimed in claim 4, wherein the quantization step sizes are determined as a function of a normal flow arising within each group in said sequence of images, said normal flow being a local component of image velocity associated with the group.

6. A method as claimed in claim 5, wherein said normal flow is computed locally for each group from at least one of image brightness data and image color data associated with the group.

7. A method as claimed in claim 5, wherein said statistic analysis of the normal flow involves computing a magnitude of a mean and a variance of the normal flow for each group.

8. A method as claimed in claim 5, wherein adjustment of the quantization step sizes for a given group is implemented in a linear manner substantially according to a relationship:
q_{—}sc_{—}m=((δ·q_{—}sc)±(λ·Γ(x)))
wherein
Γ(x)=x·e^{-(x-1)}, namely a shifted Gamma or Erlang function giving rise to non-linear modulation;
x=normal flow magnitude variance;
λ=a multiplying coefficient;
δ=a multiplying coefficient; and
q_sc=a quantization scale.

9. A method as claimed in claim 1, said method being adapted to employ a discrete cosine transform (DCT) in step (c) and to generate groups of pixels in accordance with MPEG standards.

10. Processed video data (40, 200) generated according to the method as claimed in claim 1, said data (40) being processed using quantization step sizes which are dynamically variable as a function of spatio-temporal information present in a sequence of images represented by said processed video data.

11. Processed video data (40, 200) as claimed in claim 10 stored on a data carrier, for example a DVD.

12. A processor (20) for receiving video input signals and generating corresponding processed output data (40, 200), the processor (20) being operable to apply the method as claimed in claim 1 in generating the processed output data (40, 200).

13. A method of decoding processed input data (40, 200) in a data processor (30) to generate decoded video output data (60) corresponding to a sequence of images (100), characterized in that said method includes steps of:
(a) receiving the processed input data (40, 200) at the data processor (30);
(b) processing the processed input data to generate corresponding quantized transform data;
(c) processing the quantized transform data to generate transform parameters of at least one group of pixels of the sequence of images, said processing of the transform data utilizing quantization having quantization step sizes;
(d) decoding the transform parameters into corresponding groups of pixels; and
(e) processing the groups of pixels to generate the corresponding sequence of images for inclusion in the decoded video output data (60),
wherein the data processor (30) is operable in step (d) to decode using quantization steps sizes that are dynamically variable as a function of spatio-temporal information conveyed in the sequence of images.

14. A method as claimed in claim 13, wherein the at least one group of pixels correspond to at least one block of pixels.

15. A method as claimed in claim 13, wherein the quantization step sizes employed for a given group are made dependent on spatio-temporal information which is local to the given group in the sequence of images.

16. A method as claimed in claim 13, wherein the quantization step sizes are determined as a function of statistical analysis of spatio-temporal information conveyed in the sequence of images.

17. A method as claimed in claim 16, wherein the quantization step sizes are determined as a function of a normal flow arising within each group in said sequence of images, said normal flow being a local component of image velocity associated with the group.

18. A method as claimed in claim 15, wherein said normal flow is computed locally for each group from at least one of image brightness data and image color data associated with the group.

19. A method as claimed in claim 17, wherein said statistic analysis of the normal flow involves computing a magnitude of a mean and a variance of the normal flow for each macroblock.

20. A method as claimed in claim 17, wherein adjustment of the quantization step sizes for a given group is implemented in a linear manner substantially according to:
q_{—}sc_{—}m=((δ·q_{—}sc)±(λ·Γ(x)))
wherein
Γ(x)=x·e^{-(x-1)}, namely a shifted Gamma or Erlang function giving rise to non-linear modulation;
x=normal flow magnitude variance;
λ=a multiplying coefficient;
δ=a multiplying coefficient; and
q_sc=a quantization scale

21. A method as claimed in claim 13, said method being adapted to employ a discrete cosine transform (DCT) in step (d) and to process groups of pixels in accordance with MPEG standards.

22. A processor (30) for decoding processed input data therein to generate video output data corresponding to a sequence of images, said processor (30) being operable to employ a method as claimed in claim 13 for generating the video output data (60).

23. An apparatus (10) for processing video data corresponding to a sequence of images, said apparatus including a processor (20) as claimed in claim 13.

24. An apparatus (10) as claimed in claim 23, wherein said apparatus is implemented as at least one of: a mobile telephone, a television receiver, a video recorder, a computer, a portable lap-top computer, a portable DVD player, a camera for taking pictures.

25. A system (10) for distributing video data, said system (10) including:
(a) a first processor (20) for receiving video input signals (50) corresponding to a sequence of images and generating corresponding processed output data (40, 200);
(b) a second processor (30) for decoding the processed output data (40, 200) to generate video data (60) corresponding to the sequence of images; and
(c) a data conveying arrangement (40) for conveying the encoded data from the first processor (20) to the second processor (30).

26. A system (10) as claimed in claim 25, wherein said data conveying arrangement (40) includes at least one of: a data storage medium, a data distribution network.

27. Software for executing in computing hardware for implementing the method as claimed in claim 1.

28. Software for executing in computing hardware for implementing the method as claimed in claim 13.
